(19) United States
(12) Patent Application Publication
(10) Pub. No.: US 2017/0070546 A1
(43) Pub. Date: Mar. 9, 2017

(54) COLLABORATIVE MEETING PRESENTATION SYSTEM AND METHODS

(71) Applicant: TEXAS INSTRUMENTS INCORPORATED, Dallas, TX (US)

(72) Inventors: Carlos Alejandro Gonzalez Usigli, Dallas, TX (US); Carlos Gustavo Diaz de Leon, Addison, TX (US); Sajjad Mahmood Khan, Allen, TX (US); Joe Dean Hill, Wylie, TX (US); Matt Nicolosi, Plano, TX (US); Manuel Shiosaki Gomez, Dallas, TX (US)

(21) Appl. No.: 15/256,508

(22) Filed: Sep. 2, 2016

Related U.S. Application Data
(60) Provisional application No. 62/214,062, filed on Sep. 3, 2015.

(51) Int. Cl. H04L 29/06

(52) U.S. Cl. CPC H04L 65/1089; H04L 65/1069

(57) ABSTRACT

Structures within a service controller portion of a collaboration system collect and store content captured by a client service module operating within each collaborator's computing device. From commands received from a collaboration director's portable computing device, the service controller selects individual collaborator computing devices from which to capture screen content at selected rates. Collaborator content is sent to the director's portable computing device to be monitored by the director. Under command from the director's portable computing device, the service controller may also send collaborator content to a public display computing device. The collaboration director may designate one or more collaborative participants as “live presenter(s).” A live presenter's screen content may be captured and publicly displayed at higher frame rates and in real time in order to simulate a white board or slide presentation.

### PRIORITY CLAIM

This application claims the benefit of priority under 35 U.S.C. §119(e) to U.S. Provisional Patent Application Ser. No. 62/214,062 titled “INTERACTIVE PUBLIC/PRIVATE DISPLAY SYSTEM,” filed on Sep. 3, 2015 and incorporated herein by reference in its entirety.

### TECHNICAL FIELD

Embodiments described herein relate to collaborative workgroup presentation systems, including workgroup director control of publicly-displayed subject matter received from one or more workgroup participants.

### BACKGROUND INFORMATION

Traditional models of classroom education typically include one or more teachers engaged with a group of students in a learning activity. Prior to the advent of computing devices as teaching/learning tools, a teacher would typically present material with the aid of blackboards, whiteboards, overhead projectors, etc. One or more students might also be called upon to stand before the class and make student presentations, possibly with the aid of the above-mentioned presentation devices. A teacher in this traditional classroom setting often walks around the class to observe individual student work at a student's desk.

A teacher in a more modern classroom setting may deliver presentations from a teacher's computing device. The presentations may appear as images projected onto a screen, images sent to a large-format display screen, or images received at student computing devices from the teacher's computing device.

More generally, meeting-oriented information sharing in a variety of settings, including school classrooms, corporate training and brain-storming sessions, board meetings, etc. are increasingly viewed as collaborative efforts. That is, participants traditionally known as “students” may at times, individually or in groups, originate information to be shared among others of the various participants. Although less hierarchical than traditional approaches to group meeting information sharing, a collaborative approach may include one or more individuals who guide the collaboration, referred to hereinafter as the “director” and/or “collaboration director.”

Replicating tried and true methods associated with the traditional classroom in an automated collaborative group meeting environment presents special challenges. Examples include the control of visual presentation opportunities by the various participants and enabling the collaboration director to maintain presentation control while walking around the meeting room to interact one-on-one with the participants.

### BRIEF DESCRIPTION OF THE DRAWINGS

FIG. 1 is a block diagram of a collaborative meeting presentation system according to various example embodiments of the invention.

FIG. 2 is a block diagram of a collaborative meeting presentation system illustrating an example method of client service module download according to various example sequences.

FIG. 3A is a block diagram illustrating an example method of automated collaboration, including a collaborator screen content capture command sequence.

FIG. 3B is a block diagram illustrating additional activities associated with the example method of automated collaboration, including capturing screen content at an individual collaborator's computing device and displaying the content at a director's portable computing device.

FIG. 3C is a block diagram illustrating additional activities associated with the example method of automated collaboration, including delivering individual collaborator screen content to a display at a public display computing device.

FIG. 4A is a block diagram illustrating an example method of automated collaboration, including a command sequence associated with capturing screen activity at a presenting collaborator's computing device.

FIG. 4B is a block diagram illustrating additional activities associated with the example method of automated collaboration, including capturing screen activity at a presenter's computing device and privately displaying the screen activity at a director's portable computing device.

FIG. 4C is a block diagram illustrating additional activities associated with the example method of automated collaboration, including delivering presenter screen activity to a display at a public display computing device.

### SUMMARY OF THE INVENTION

Structures and methods disclosed herein are collectively denominated “the collaboration system.” The collaboration system enables the orderly presentation of visual and audio materials (“content”) by and to collaborative participants in a group meeting setting. The term “screen content” may optionally include audio information as described in detail below.

Structures within a service controller portion of the collaboration system collect and store content captured by a client service module operating within each collaborator's computing device. From commands received from a collaboration director's portable computing device, the service controller selects individual collaborator computing devices from which to capture screen content and determines the rate of capture at each collaborator computing device. The captured content is buffered and/or permanently stored by the service controller.

Collaborator content is sent to the director's portable computing device to be monitored by the director. Under command from the director's portable computing device, the service controller may also send collaborator content to a public display computing device. The public display computing device displays such content, denominated “public” content, to the collaboration group via large screen projection, direct display on one or more attached flat screen monitors, etc.

The collaboration director may designate one or more collaborative participants as “live presenter(s).” A live presenter's content may be captured and publicly displayed at higher frame rates and in real time in order to simulate the presenter's making a white board or slide presentation.

The portable nature of the collaboration director's computing device facilitates the director's mobility, enabling him/her to walk around the room to engage one-on-one with individual collaborators while monitoring the content from all collaborators and making periodic “presenter” assignments.

### DETAILED DESCRIPTION

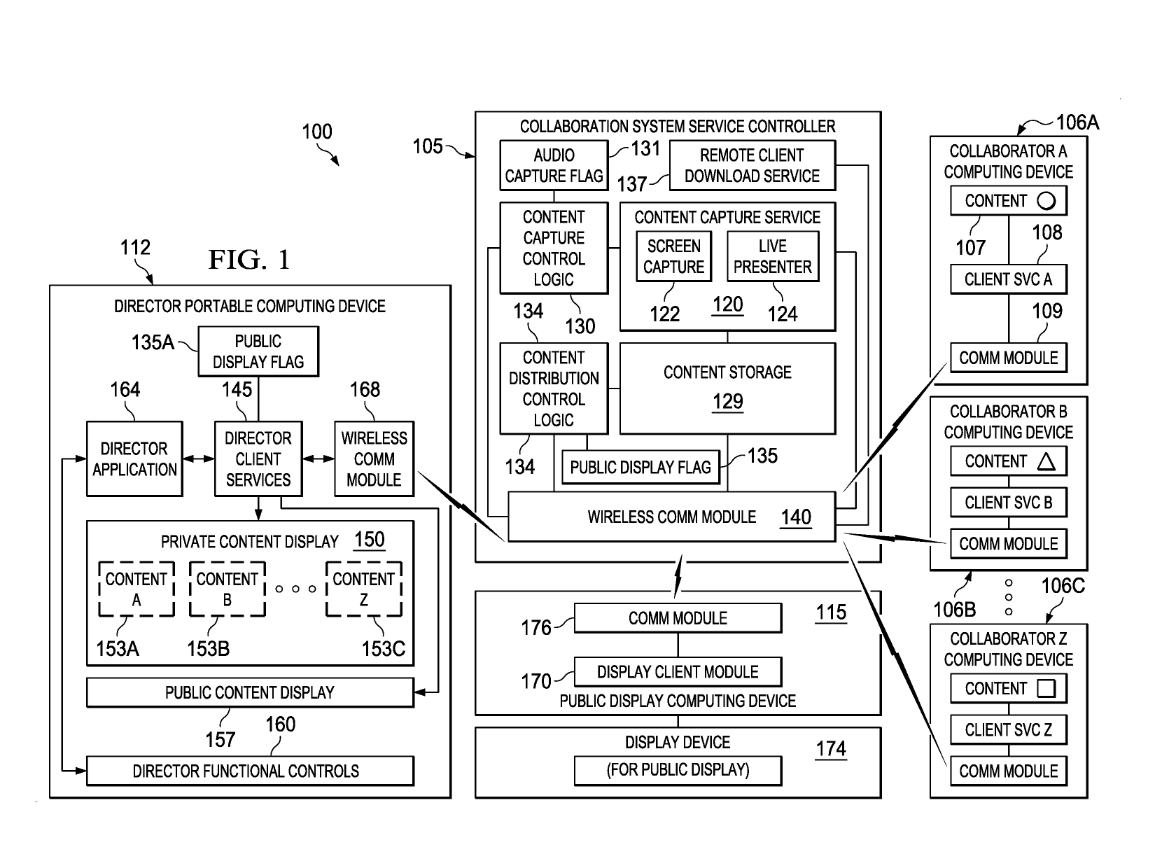

FIG. 1 is a block diagram of a collaborative meeting presentation system 100 according to various example embodiments of the invention. The presentation system 100 includes a collaboration system service controller 105. The collaboration system service controller 105 receives and stores visual and/or audio content from a plurality of collaborator computing devices (e.g., the collaborator computing devices 106A, 106B and 106C corresponding to collaborators A, B, and C respectively). The presentation system 100 also includes a director portable computing device 112 communicatively coupled to the service controller 105. The director portable computing device 112 sends control commands to the service controller 105 and receives and displays content from the collaborator computing devices (e.g., the content of display 107 from the collaborator A computing device 106A). The collaboration display system 100 further includes a public display computing device 115 communicatively coupled to the service controller 105. The public display computing device 115 receives and displays selected portions of the content to a group of collaborators (e.g., the collaborators A, B, and C).

Each of the computing devices 105, 106, 112 and 115 includes a processor for executing instructions, memory for storing instructions and data, a communication module for sending data and control packets between computing devices, and one or more buses to couple the processor, memory and communication module, all as is well-known in the art.

Examined in greater detail, each collaborator computing device (e.g., the collaborator A computing device 106A) includes a content display (e.g., the content display 107). Each collaborator computing device also includes a client service module (e.g., the client service module 108) coupled to the content display to capture display content. Each collaborator computing device also includes a communication module (e.g., the communication module 109) coupled to the client service module to receive capture mode commands from the service controller 105 and to send the captured display content to the service controller 105.

The collaboration system service controller 105 includes a content capture service module 120. The content capture service module 120 initiates capture of content at designated collaborator computing devices at designated capture rates and initiates storage of the content at the service controller 105. Screen capture logic 122 may designate slower rates for screen capture at many collaborator computing devices. Live presenter logic 124 may designate higher capture rates for a “live presenter” mode in which one or a few collaborator computing devices capture all activity at their screens in real time.

The service controller 105 also includes a content storage module 129 coupled to the content capture service module 120. The content storage module 129 stores and buffers streams of screen content captured at the designated collaborator computing devices. Subsequently, content is selectively read from the content storage module 129 for distribution and display.

The service controller 105 also includes a content capture control logic module 130 coupled to the content capture service module 120. The content capture control logic module 130 receives content capture commands from the director portable computing device 112. Such content capture commands include commands to designate collaborator computing devices from which to capture content, commands to designate a content capture rate associated with each designated collaborator computing device, and a state of an audio capture flag (e.g., the audio capture flag 131) to specify audio capture on or off for each designated collaborator computing device, among others.

The service controller 105 further includes a content distribution control logic module 134 coupled to the content storage module 129. The content distribution control logic module 134 receives content distribution commands from the director portable computing device 112. Such commands include a state of a public display flag 135A, 135B and a field specifying an age of stored content to display. In some embodiments of the collaborative meeting presentation system 100, content distribution control logic commands are collaborator computing device specific.

Some embodiments of the service controller 105 also include a remote client download service module 137. The remote client download service module 137 stores a collaborator computing device client service module and downloads the client service module to a newly-connected collaborator computing device.

The collaboration system service controller 105 also includes a wireless communication module 140 coupled to the remote client download service module 137, to the content capture control logic module 130, to the content distribution control logic module 134, and to the content storage module 129. The wireless communication module 140 receives command packets from the director portable computing device 112 and sends content data packets to the director portable computing device 112. The director portable computing device 112 utilizes wireless communication to enable portability in order to allow walk-around interaction between the director and the individual collaborators. The wireless communication module 140 also communicates with the collaborator computing devices and with the public display computing device 115. The service controller 105 may also include a wired packet communication controller (e.g., Ethernet, not shown) to communicate with the collaborator computing devices and/or to communicate with the public display computing device 115 if the collaboration environment is more conducive to the latter devices being wired.

Considering now the director portable computing device 112 in greater detail, a director client services module 145 sends director-originated content capture and content distribution commands to the service controller 105. The director client services module 145 also directs private and public content (e.g., content A 153A, content B 153B and content Z 153C) received at the director portable computing device 112 to predetermined display areas (e.g., to the private content display area 150 and to the public content display area 157). The director portable computing device 112 also includes a set of director functional controls 160 communicatively coupled to the director client services module 145. The director functional controls 160 accept director command input.

The director portable computing device 112 further includes a director application module 164 coupled to the set of director functional controls 160. The director application module 164 performs actions based upon director command input, including designating collaborator content for private or public display and assigning live presenter status to one or more collaborators. The director portable computing device 112 also includes a wireless communication module 168 coupled to the director client services module 145. The wireless communication module 168 sends command packets to the service controller 105 and receives content packets from the service controller 105.

The public display computing device 115 of the collaborative meeting presentation system 100 includes a display client module 170. The display client module 170 receives content from the service controller 105 designated for public display. The public display computing device 115 also includes a display device 174 coupled to the display client module 170. The display device 174 displays the public content. The public display computing device 115 further includes a wired or wireless communications module 176 coupled to the display client module 170. The communications module 176 receives content data packets from the service controller 105 containing content for public display.

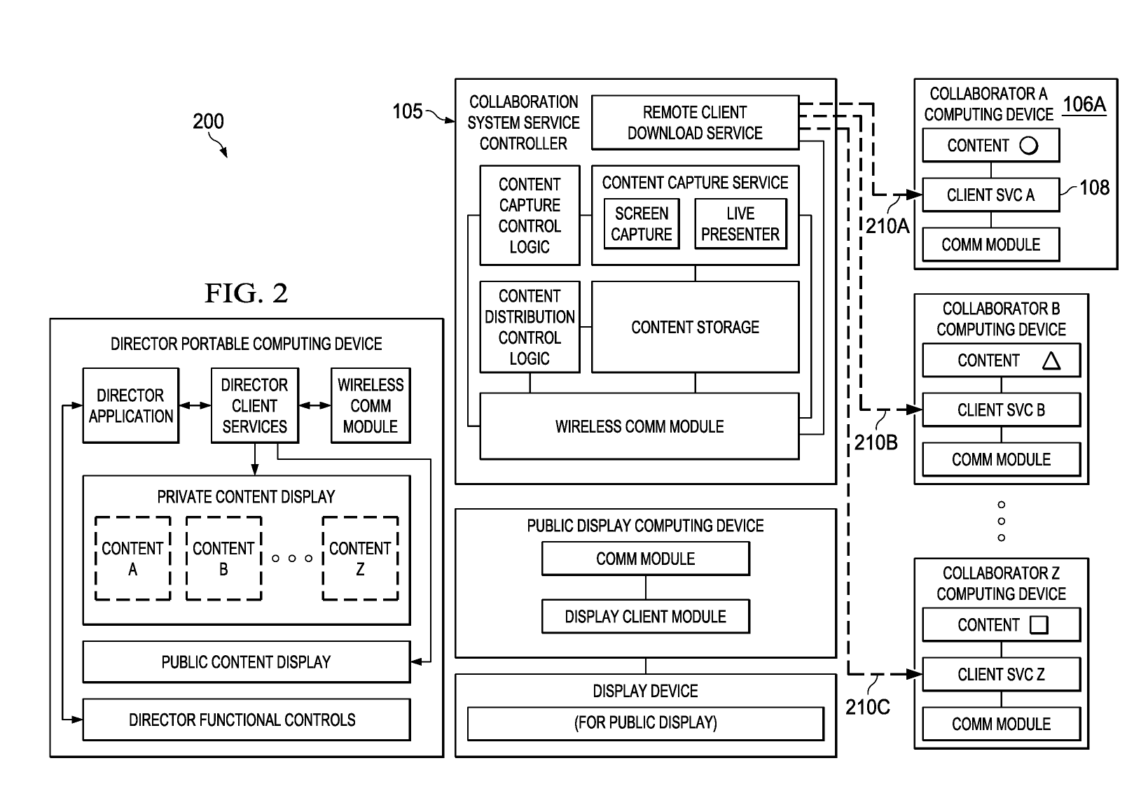

FIG. 2 is a block diagram of a collaborative meeting presentation system illustrating an example method 200 of client service module download according to various example sequences. Upon first connecting with the collaboration system service controller 105, a collaborator computing device (e.g., the device 106A) receives a download (e.g., the downloads 210A, 210B and 210C) of instructions used to participate in the collaborative meeting presentation system 100 of FIG. 1. Such instructions include a client service module (e.g., the client service module 108) with a protocol stack used to receive and decode command packets, to capture collaborator computing device screen and (optionally) audio content, and to encode the captured content for transmission to the service controller 105. It is noted that the collaborator computing device downloads (e.g., the downloads 210A, 210B and 210C) may include client service modules appropriate to the make, model and operating system of each collaborator computing device.

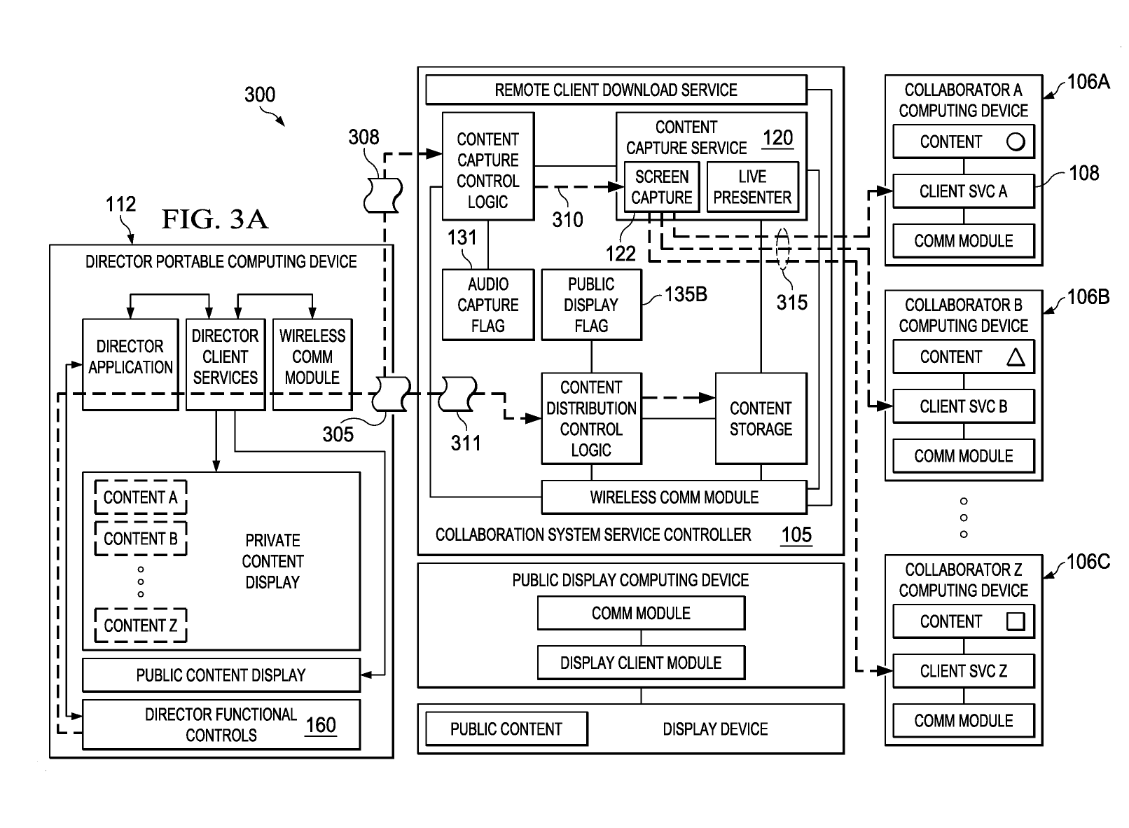

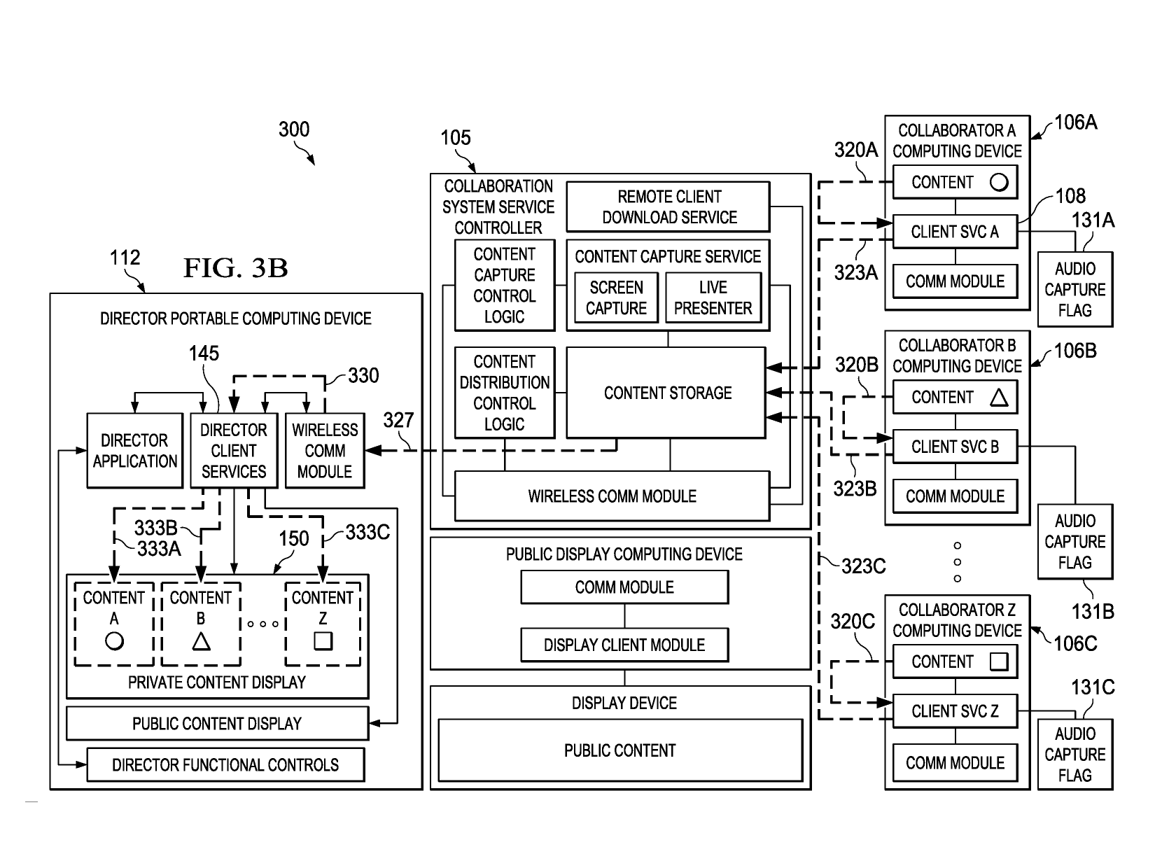

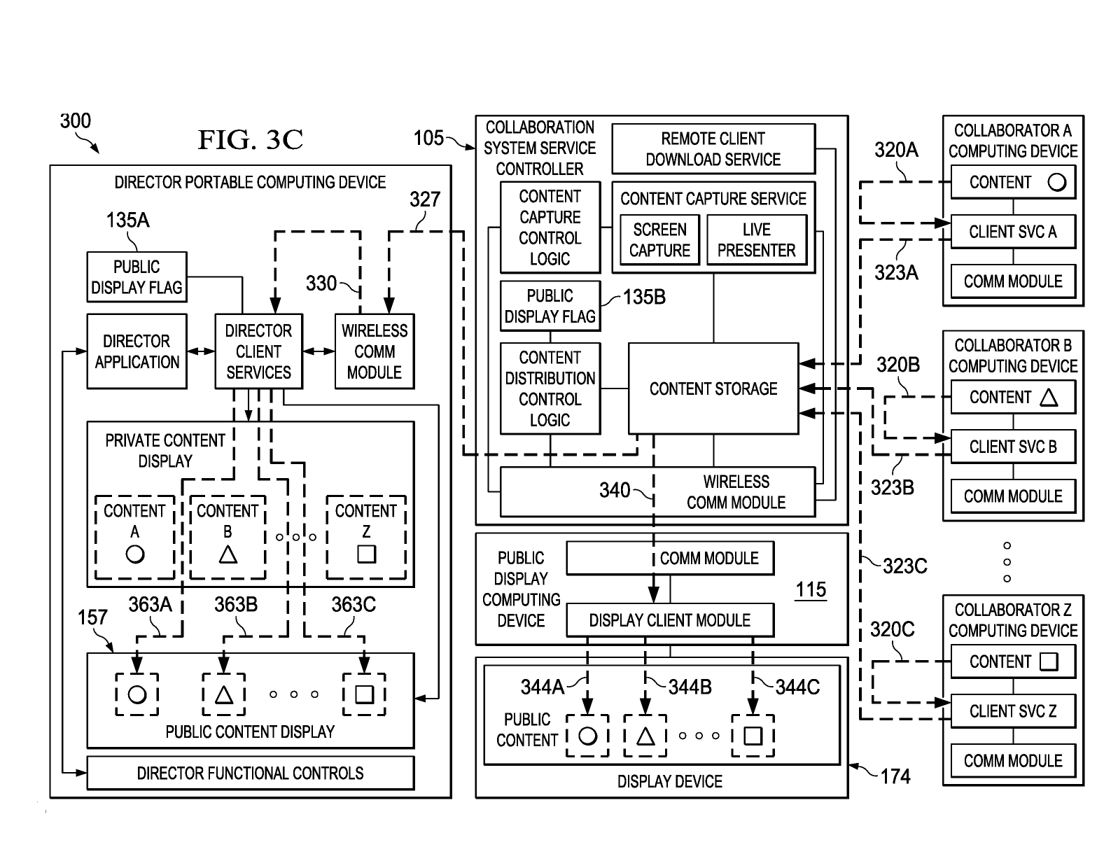

FIG. 3A is a block diagram illustrating an example method of automated collaboration 300, including a collaborator screen content capture command sequence. A director exercises director functional controls 160 at a director portable computing device 112 (e.g., the functional controls 160 of the device 112 of FIG. 1) to initiate collaborator screen capture activities. The method 300 commences at the director portable computing device 112 with assembling director inputs into a packetized command string 305. The method 300 includes receiving the command string 305 at a collaboration system service controller 105 (e.g., the service controller 105 of FIG. 1). The command string 305 includes one or more screen content capture parameters 308 and one or more screen content distribution parameters 311.

The screen content capture parameters 308 include a selection of a group of collaborator computing devices (e.g., the devices 106A, 106B and 106C) from which to capture screen content. The screen content capture parameters 308 also include a screen content capture rate associated with each collaborator computing device of the selected group and a state of an audio capture flag associated with each collaborator computing device of the selected group (e.g., the audio capture flag 131). The screen content distribution parameters 311 include one or more of a capture-to-display delay period associated with content captured at each collaborator computing device of the selected group and a state of a public display flag associated with content captured at each collaborator computing device of the selected group (e.g., the public display flag 135B).

The method 300 continues at activity 310 with configuring a screen capture component 122 of a content capture service 120 within the service controller 105. The content capture service 120 is configured to capture screen content from the designated group of collaborator computing devices (e.g., the devices 106A, 106B and 106C) at selected rates. The method 300 also includes sending one or more screen content capture commands from the service controller 105 to a client service module associated with each of the selected group of collaborator computing devices (e.g., the client service module 108 associated with the collaborator A computing device), at activity 315. The screen content capture commands include the screen content capture rate and/or the state of the audio capture flag 131.

FIG. 3B is a block diagram illustrating additional activities associated with the example method of automated collaboration 300, including capturing screen content at an individual collaborator computing device (e.g., at the device 106A) and displaying the content at a director portable computing device 112. The method 300 continues at the client service module corresponding to each of the selected group of collaborator computing devices (e.g., the client service module 108 of the collaborator computing device 106A) with capturing screen content of the corresponding collaborator computing device at the selected rate (e.g., activities 320A, 320B and 320C). The method 300 optionally includes checking the state of the audio capture flag at each of the selected group of collaborator computing devices (e.g., the audio capture flags 131A, 131B and 131C). If the audio capture flag is set at a particular collaborator computing device, the method 300 includes capturing an audio stream synchronized to the selected screen content capture rate at the corresponding collaborator computing device.

The method 300 also includes receiving, at the service controller 105, a stream of captured screen content from each of the selected plurality of collaborator computing devices (e.g., activities 323A, 323B and 323C). The method 300 further includes storing and/or buffering, at the service controller 105, the received streams of captured screen content from each of the selected group of collaborator computing devices. The method 300 also includes sending the streams of captured screen content to the director portable computing device 112 for display, at activity 327.

The method 300 continues at the director portable computing device 112 with receiving the streams of captured screen content at the director client services module 145, at activity 330. The method 300 also includes displaying the streams of captured screen content in sections of a private content display area (e.g., activities 333A, 333B and 333C).

FIG. 3C is a block diagram illustrating additional activities associated with the example method of automated collaboration 300, including delivering individual collaborator screen content to a display 174 at a public display computing device 115. The method 300 continues at the service controller 105 with checking the logical state of the public display flag associated with each of the received streams of captured screen content (e.g., the public display flag 135B). The method 300 includes sending streams of captured screen content for which the public display flag is set to the public display computing device 115, at activity 340. The method 300 also includes displaying the streams of captured screen content for which the public display flag is set in a predetermined area of the display associated with the public display computing device (e.g., activities 344A, 344B and 344C).

The method 300 continues at the director portable computing device 112 with checking the logical state of the public display flag associated with each of the received streams of captured screen content (e.g., the public display flag 135A). The method 300 also includes displaying the streams of captured screen content for which the public display flag is set in a public content display area 157 of the director portable computing device 112 (e.g., activities 363A, 363B and 363C).

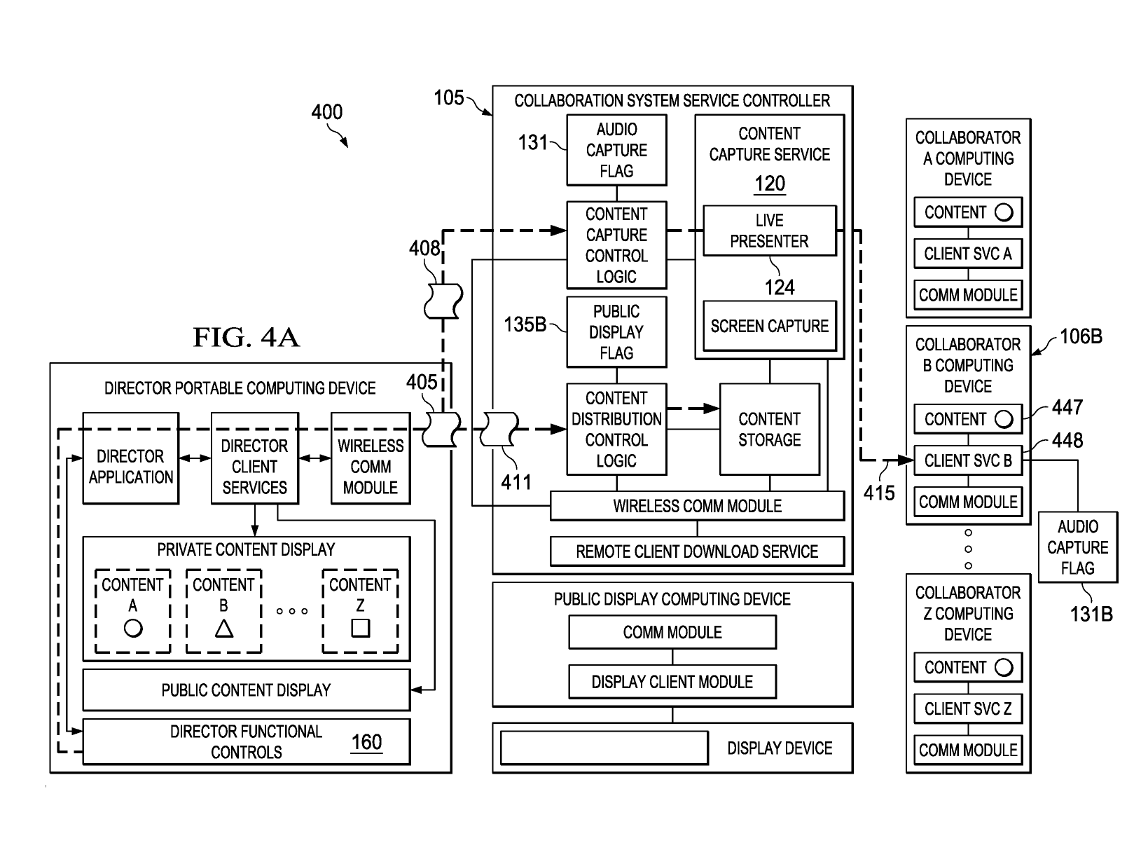

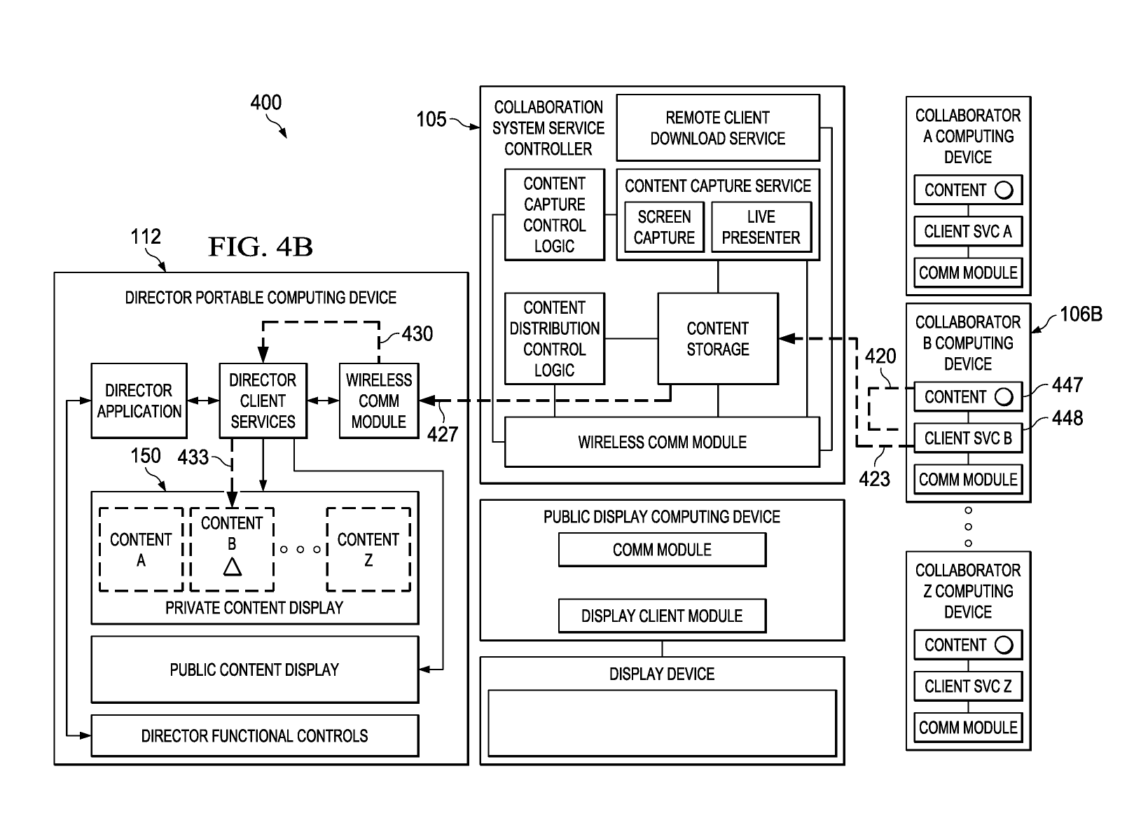

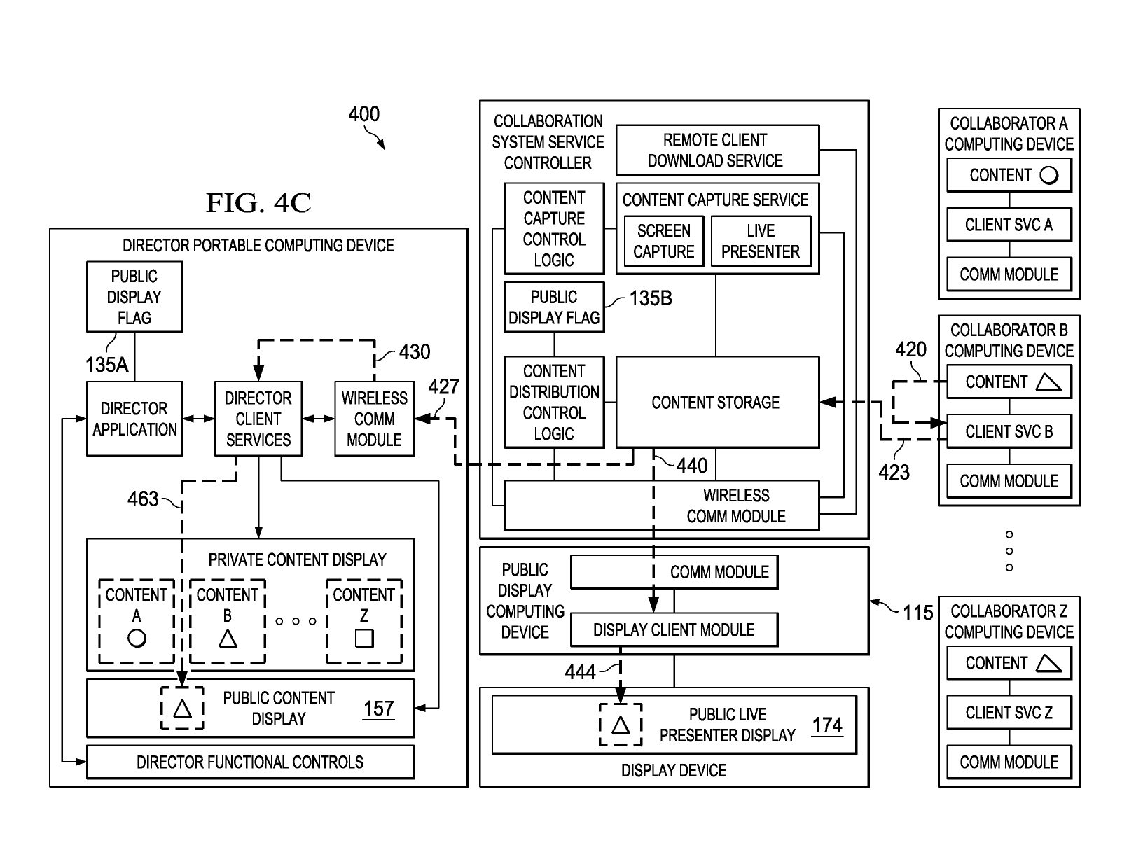

FIG. 4A is a block diagram illustrating an example method of automated collaboration 400, including a command sequence associated with capturing screen activity at a presenting collaborator computing device (e.g., at the presenting collaborator computing device 106B). The method 400 is similar to the method 300 described above. Activities which are different between the methods 300 and 400 are emphasized here below in the description of the method 400.

A director exercises director functional controls 160 at a director portable computing device 112 (e.g., the functional controls 160 of the device 112 of FIG. 1) to initiate collaborator screen capture activities. The method 400 commences at the director portable computing device 112 with assembling director inputs into a packetized command string 405. The method 400 includes receiving the command string 405 at a collaboration system service controller 105 (e.g., the service controller 105 of FIG. 1). The command string 405 includes one or more screen content capture parameters 408 and one or more screen content distribution parameters 411.

Potential screen content capture parameters 408 include the designation of one or more collaborator computing devices (e.g., the collaborator computing device 106B) as “live presenters.” A live presenter's content may be captured and publicly displayed at higher frame rates and in real time in order to simulate the presenter's making a white board or slide presentation. The screen content capture parameters 408 may also include a state of an audio capture flag 131 to be set in a presenter's client service module (e.g., the audio capture flag 131B set in the client service module 448). Screen content distribution parameters 411 include a state of a public display flag associated with content captured at a presenter's collaborator computing device (e.g., the public display flag 135B).

The method 400 continues at activity 410 with configuring a live presenter capture component 124 of a content capture service 120 within the service controller 105. The content capture service 120 is configured to capture screen content from the live presenter at a capture rate sufficient to reproduce all activity appearing at a primary display screen 447 associated with the live presenter collaborator computing device (e.g., the collaborator computing device 106B) in real-time. The method 400 also includes sending one or more screen content capture commands from the service controller 105 to a client service module associated with each live presenter collaborator computing device (e.g., the client service module 448 associated with the collaborator computing device 106B), at activity 415.

FIG. 4B is a block diagram illustrating additional activities associated with the example method of automated collaboration 400, including capturing screen activity at a presenter's computing device (e.g., the presenting collaborator computing device 106B and privately displaying the screen activity at a director portable computing device 112. The method 400 continues at the client service module corresponding to the presenter's collaborator computing device (e.g., the client service module 448) with capturing the presenter's screen content (e.g., activity 420 from the display 447). The method 400 optionally includes checking the state of the audio capture flag (e.g., the audio capture flag 131B) at the presenter's collaborator computing device. If the audio capture flag is set, the method 400 includes capturing an audio stream synchronized to the presenter's screen content capture rate.

The method 400 also includes receiving a stream of captured screen content from the presenter's collaborator computing device at the service controller 105 (e.g., activity 423). The method 400 further includes storing and/or buffering the received stream of captured screen content at the service controller 105. The method 300 also includes sending the presenter's stream of captured screen content to the director portable computing device 112 for display, at activity 427.

The method 400 continues at the director portable computing device 112 with receiving the presenter's stream of captured screen content, at activity 430. The method 400 also includes displaying the presenter's stream of captured screen content in a private content display area 150 (e.g., activity 433).

FIG. 4C is a block diagram illustrating additional activities associated with the example method of automated collaboration 400, including delivering presenter screen activity to a display 174 at a public display computing device 115. The method 400 continues at the service controller 105 with checking the logical state of the public display flag 135B associated with the presenter's stream of captured screen content. The method 400 includes sending the presenter's stream of captured screen content to the public display computing device 115 if the public display flag 135B is set, at activity 440. In the latter case, the method 400 also includes displaying the presenter's stream of captured screen content on the display 174 associated with the public display computing device 115 (e.g., activity 444).

The method 400 continues at the director portable computing device 112 with checking the logical state of the public display flag 135A associated with the presenter's stream of captured screen content. The method 400 also includes displaying the presenter's stream of captured screen content in a public content display area 157 of the director portable computing device 112 if the public display flag 135A is set (e.g., activity 463).

Apparatus and methods described herein may be useful in applications other than the example apparatus 100 and the example methods 200, 300 and 400. The latter are intended to provide a general understanding of the structures of various embodiments and the sequences associated with various methods. They are not intended to serve as complete descriptions of all elements and features of apparatus, systems and methods that might make use of these example structures and sequences.

By way of illustration and not of limitation, the accompanying figures show specific embodiments in which the subject matter may be practiced. It is noted that arrows at one or both ends of connecting lines are intended to show the general direction of electrical current flow, data flow, logic flow, etc. Connector line arrows are not intended to limit such flows to a particular direction such as to preclude any flow in an opposite direction. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense. The breadth of various embodiments is defined by the appended claims and the full range of equivalents to which such claims are entitled.

The inventive subject matter disclosed herein may be referred to individually or collectively by the term “invention” merely for convenience and without intending to voluntarily limit this application to any single invention or inventive concept, if more than one is in fact disclosed. Accordingly, although specific embodiments have been illustrated and described herein, any arrangement calculated to achieve the same purpose may be substituted for the specific embodiments shown. This disclosure is intended to cover any and all adaptations or variations of various embodiments.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the preceding Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. The following claims are hereby incorporated into the Detailed Description, with each claim standing with the claims from which it depends as a separate embodiment.

What is claimed is:

1. A collaborative meeting presentation system, comprising:
a collaboration system service controller to receive and store at least one of visual or audio content from a plurality of collaborator computing devices;
a director portable computing device communicatively coupled to the service controller to send mode control commands to the service controller and to receive and display the content; and
a public display computing device communicatively coupled to the service controller to receive and display selected portions of the content to a group of collaborators.

2. The collaborative meeting presentation system of claim 1, the collaboration system service controller further comprising:
a content capture service module to initiate content capture from designated collaborator computing devices at designated screen capture rates and to initiate storage of the content;
a content storage module coupled to the content capture service module, the content storage module to store the content and from which to read the content;
a content capture control logic module coupled to the content capture service module to receive content capture commands from the director portable computing device, the content capture commands to include commands to designate collaborator computing devices from which to capture content, commands to designate a content capture rate associated with each designated collaborator computing device, and commands to specify audio capture on or off for each designated collaborator computing device; and
a content distribution control logic module coupled to the content storage module to receive content distribution commands from the director portable computing device, the content distribution commands to include a state of a public display flag and a field specifying an age of stored content to display.

3. The collaborative meeting presentation system of claim 1, the collaboration system service controller further comprising:
a remote client download service module to store a collaborator computing device client service module and to download the client service module to a newly-connected collaborator computing device.

4. The collaborative meeting presentation system of claim 3, the collaboration system service controller further comprising:
a wireless communication module coupled to the remote client download service module, to the content capture control logic module, to the content distribution control logic module and to the content storage module to receive command packets from the director portable computing device and to send content data packets to the director portable computing device, to send command packets to the plurality of collaborator computing devices and to receive content packets from the plurality of collaborator computing devices, and to send content packets to the public display computing device.

5. The collaborative meeting presentation system of claim 1, the director portable computing device further comprising:
a director client services module to send director-originated content capture and content distribution commands to the service controller and to direct private and public content received at the director portable computing device to predetermined display areas;
a set of director functional controls communicatively coupled to the director client services module to accept director command input; and
a director application module coupled to the set of director functional controls to perform actions based upon the director command input, including designating collaborator content for private or public display and assigning live presenter status to one or more collaborators.

6. The collaborative meeting presentation system of claim 5, the director portable computing device further comprising:
a wireless communication module coupled to the director client services module to send command packets to the service controller and to receive content packets from the service controller.

7. The collaborative meeting presentation system of claim 1, the public display computing device further comprising:
a display client module to receive content from the service controller designated for public display;
a display device coupled to the display client module to display the public content; and
a communication module coupled to the display client module to receive content data packets from the service controller.

8. The collaborative meeting presentation system of claim 1, each collaborator computing device further comprising:
a content display;
a client service module coupled to the content display to capture display content; and
a communication module coupled to the client service module to receive capture mode commands from the service controller and to send the captured display content to the service controller.

9. A method of screen content capture and display associated with a collaborative meeting presentation system, comprising:
at a collaboration system service controller, receiving a command string from a director portable computing device, the command string to include at least one screen content capture parameter and at least one screen content distribution parameter;
configuring a screen capture component of a content capture service within the service controller to capture screen content from a selected plurality of collaborator computing devices at selected rates;
sending at least one screen content capture command from the service controller to a client service module associated with each of the selected plurality of collaborator computing devices;
at the service controller, receiving a stream of captured screen content from each of the selected plurality of collaborator computing devices;
sending the streams of captured screen content to the director portable computing device for display; and
sending the streams of captured screen content to a public display computing device for public display if a public display flag is set.

10. The method of screen content capture and display of claim 9, the screen content capture parameter being a list of the selected plurality of collaborator computing devices, a screen content capture rate associated with at least one of the selected plurality of collaborator computing devices, or a state of an audio capture flag associated with at least one of the selected plurality of collaborator computing devices.

11. The method of screen content capture and display of claim 10, the screen content capture command to include at least one of the screen content capture rate or the state of the audio capture flag.

12. The method of screen content capture and display of claim 9, the screen content distribution parameter being a capture-to-display delay period associated with at least one of the selected plurality of collaborator computing devices or the state of the public display flag associated with at least one of the selected plurality of collaborator computing devices.

13. The method of screen content capture and display of claim 9, further comprising:
at the director portable computing device, assembling the command string from a set of director inputs.

14. The method of screen content capture and display of claim 13, further comprising:
at the client service module corresponding to at least one of the selected plurality of collaborator computing devices, capturing screen content at the selected capture rate;
checking the state of the audio capture flag; and
capturing an audio stream synchronized to the selected screen content capture rate if the audio capture flag is set.

15. The method of screen content capture and display of claim 9, further comprising:
at the service controller, storing the stream of captured screen content received from each of the selected plurality of collaborator computing devices; and
checking the state of the public display flag.

16. The method of screen content capture and display of claim 9, further comprising:
at the director portable computing device, receiving the streams of captured screen content;
displaying the streams of captured screen content in a private content display area;
checking the state of the public display flag; and
displaying the streams of captured screen content in a public content display area if the public display flag is set.

17. A method of live presentation control and display associated with a collaborative meeting presentation system, comprising:
at a collaboration system service controller, receiving a command string from a director portable computing device, the command string to include a designation of at least one of a plurality of collaborator computing devices as a live presenter, a state of a public display flag, and a state of an audio capture flag;
configuring a content capture service within the service controller for screen content capture from the live presenter at a capture rate sufficient to reproduce all activity appearing at a primary display screen associated with the live presenter collaborator computing device in real-time (“live presenter content”);
sending at least one capture command from the service controller to a client service module associated with the live presenter to initiate capture of the live presenter content and to optionally initiate capture of an audio stream synchronized with the live presenter content;
at the service controller, receiving the live presenter content and the audio stream from the live presenter;
sending the live presenter content to the director portable computing device for display; and
sending the live presenter content and the audio stream to a public display computing device for public display if the public display flag is set.

18. The method of live presentation control and display of claim 17, further comprising:
at the live presenter client service module, capturing the live presenter content;
checking the state of the audio capture flag;
capturing the audio stream if the audio capture flag is set; and
sending the live presenter content and the audio stream to the service controller for storage and re-distribution.

19. The method of live presentation control and display of claim 17, further comprising:
at the service controller, storing the live presenter content; and
checking the state of the public display flag.

20. The method of live presentation control and display of claim 17, further comprising:
at the director portable computing device, receiving the live presenter content;
displaying the live presenter content in a private content display area;
checking the state of the public display flag; and
displaying the live presenter content in a public content display area if the public display flag is set.
